(19) United States
(12) Patent Application Publication
(10) Pub. No.: US 2020/0282476 A1
(43) Pub. Date: Sep. 10, 2020

(54) DEVICE FOR MACHINING INTERNAL CHANNELS AND RESPECTIVE METHOD OF OPERATION

(71) Applicant: CHETOCORPORATION, S.A., Oliveira De Azemeis (PT)

(72) Inventor: Sergio David TAVARES ANDRE, Vale De Cambra (PT)

(21) Appl. No.: 16/762,858

(22) PCT Filed: Nov. 13, 2018
(86) PCT No.: PCT/IB2018/058896

§ 371 Date: May 8, 2020

(30) Foreign Application Priority Data
Nov. 14, 2017 (PT) 110411

(51) Int. Cl. B23C 3/30

(52) U.S. Cl. CPC B23C 3/30

(57) ABSTRACT

This application describes a device for machining internal channels, couplable to mechanical drilling apparatus, configured to generate rotational and longitudinal movement, such as machine tools for drilling, milling and turning. A method is similarly described for operating the respective device, which allows the action of the cutting tool in accordance with a set of parameters programmed by an operator. Using this device, it is possible to endow the cited apparatus with a capacity to machine internal channels, conferring on them a function that is not common to them.

### TECHNICAL FIELD

The present application describes a device for machining internal channels and a respective method of operation.

### PRIOR ART

The document US2017266731 discloses a method and apparatus for machining an internal surface of a differential case. A lathe having a turret and a pair of spindles are in electrical communication with a programmable computer. Integrally connected to the turret is a cutter gripper assembly that is selectively grippingly engageable with a cutter. A differential case is mounted horizontally within a mount assembly on a tabletop of the lathe. Once the cutter gripping assembly engages the cutter, the turret moves toward the differential case until the cutter is in a start position within the hollow portion of the case aligned with openings in a first and second tubular portion of the case and the pair of spindles. The pair of spindles then drivingly engage the cutter and the cutter machines a first and second internal machining surface as the cutter moves from a first cutting position to a second cutting position.

The document CN202155542 discloses an integrated boring cutter for roughly and finely machining a large-sized irregular part. The integrated boring cutter is characterized in that a boring cutter body is fixed on a boring cutter spindle by a boring cutter spindle fixing bolt; a spindle hole is arranged in the center of a fixed flange; a left adjustment sliding plate is fixed at the left end of the boring cutter body by a plurality of bolts; a rough machining boring head is fixed on the left adjustment sliding plate by a rough machining boring head fixing bolt; a right adjustment sliding plate is fixed at the right end of the boring cutter body by a plurality of counter sunk bolts and is provided with a dovetail groove; a movable dovetail groove adjustment sliding plate is arranged in the dovetail groove; a fine boring head is arranged on the movable dovetail groove adjustment sliding plate; and a fine adjustment button and a fine machining cutter blade are arranged on the fine boring head. With the adoption of the integrated boring cutter, the machining aperture range is wide, the rough machining efficiency is fast, the fine machining efficiency is high, the integrated boring cutter is convenient and fast to use and is low in cost, and frequent cutter replacement is avoided.

None of the above mentioned documents solve the problem of conferring a mechanical drilling apparatus with the capacity to machine internal channels.

### SUMMARY

The present application describes a device for machining internal channels characterized by the fact that it comprises:
a coupling structure, for connection to a machine tool;
a cutting tool, for machining internal channels, connected to the machine tool through the coupling structure;
a control unit comprising computational means adapted to operate the machine tool and the cutting tool;

Wherein the coupling structure comprises:
a rotation adapter for connection to the machine tool;
a torque cone which connects to the rotation adapter;
a command rod which engages the torque cone and activates the cutting tool.

In a particular embodiment of the device, the cutting tool comprises a cutting surface equipped with at least one retractable blade activated by the command rod.

In a particular embodiment of the device, the cutting surface of the machine tool is of variable length.

In another particular embodiment of the device, the cutting surface of the cutting tool has a cylindrical geometry.

In another particular embodiment of the device, the length of the command rod is defined by the length of the cutting surface of the cutting tool.

In another particular embodiment of the device, the control unit comprises a communication module configured to establish the interaction with the controller of the machine tool.

In another particular embodiment of the device, the control unit comprises at least one peripheral input device and at least one peripheral data output device.

In another particular embodiment of the device, the peripheral data input device is of the keyboard type.

In yet another particular embodiment of the device, the peripheral data output device is a screen.

This application also describes the respective method for operating the device for machining internal channels, the cited method being characterized by the fact that it comprises the following steps:
parameterization of the operating parameters, in the control unit of the device;
   programming of the rotational movement;
   programming of the longitudinal movement;
   programming of the radial movement;
the control unit commands the machine tool, in accordance with the programmed longitudinal and rotational movement;
the machine tool generates the longitudinal and rotational movements, which are transmitted to the cutting tool through the coupling structure formed by the rotation adapter and the torque cone;
the torque cone in accordance with the programmed radial movement, which activates the command rod responsible for commanding the degree of lift of the retractable blades based on the programmed value.

### GENERAL DESCRIPTION

The present application describes a device for machining internal channels, couplable to mechanical drilling apparatus configured to generate rotational and longitudinal movement, such as machine tools for drilling, milling and turning. Using this device, it is possible to endow the cited apparatus with a capacity to machine internal channels, conferring on them a function that is not common to them.

For this purpose, the device for machining internal channels comprises a coupling structure, a control unit and a tool for machining internal channels, referred to hereafter as a cutting tool.

Moreover, a method of operating the respective device is also described, which allows the action of the cutting tool in accordance with a set of parameters programmed by an operator.

For this purpose, the developed device is installed in the mechanical apparatus, hereafter referred to as the machine tool, using the coupling structure which ensures not only the powering of said device, through the machine tool, but also allows the correct transmission of the rotational and longitudinal movements, produced thereby, to the cutting tool. In addition to the cited rotational and longitudinal movements it is also possible to configure a radial movement, which is parameterized in the control unit of the device, which, thus, commands the action of the machine tool and operates the cutting tool. The programming of the cited control unit is made through a user interface which allows its operator to configure the limits of the cutting tool and respective kinematics.

The coupling structure is responsible for the connection between the machine tool and the cutting tool, being comprised of a grip tether which, at one end, engages the machine tool and, at the opposite end, fits into a rotating interface. The latter connects to a rotation adapter which is interconnected, through docking mechanisms, to the device itself. The rotation adapter, in turn, is connected to a torque cone, which allows the coupling to the cutting tool and the correct transmission of the radial movement thereto. This mechanical transmission chain allows the operator to control the action of the rotational and longitudinal movements, generated by the machine tool, and the radial movements to be applied to the cutting tool, in accordance with the parameters programmed in the control unit of the device. As a result, it is possible to create internal channels along the part being machined—controlling the longitudinal movement of the machine tool—with a variable depth—and controlling the rotational and radial movements.

The control unit of the device is responsible, based on the parameters inserted by the operator, for activating the machine tool, in relation to the rotational and longitudinal parameters, which is to say, the forward and backwards movements, and the cutting tool, in accordance with the programmed radial parameter. For this purpose, the control unit of the device also comprises a communication module which allows the interaction with the controller of the machine tool, thus enabling access to control the operation. In turn, the control of the cutting tool is made through a physical connection between the device and the machine tool, enabled by the coupling structure, specifically through the connection between the rotation adapter and the torque cone, which allows the transmission and materialization of the control information, as programmed, to the cited tool.

The control unit establishes the interface with the user on two levels: content visualization, using the peripheral data output devices, such as a screen; and parameter programming, through the peripheral input devices of the mouse type, physical or tactile keyboard, where the screen for visualizing the data supports such technology.

The cutting tool comprises a cutting surface and an internal command rod, which engages the torque cone connected to the device through the rotation adapter. By way of illustration, the cutting surface may have a cylindrical geometry, which is referred to as the cutting cylinder head. The length of the internal rod is variable, and is related to the effective length of the said cutting head and, by extension, of the cutting tool. The cutting cylinder head comprises at least one retractable blade, inserted into its surface, which is responsible for the machining of the channel on the inside of the parts. The action of these blades is triggered by the internal rod of the tool which, through the torque cone, controls the lift degree of the blades, in accordance with the radial parameter programmed by the operator—which is to say, in accordance with the diameter desired for the internal channel. In effect, in accordance with the radial parameter, the torque cone activates the internal rod, where the longitudinal movement thereof, in a fixed displacement interval, is responsible for roughly lifting the cutting blades.

As such, the programming of the control of the device, regarding the rotational, longitudinal and radial parameters, allows the configuration of the internal channels along the parts being machined, at different depths.

As regards the operating method of the device, the following steps are executed:
assembly of the device in the machine tool;
aligning and fixing the part to be machined;
parameterization of the operating parameters, in the control unit of the device:
   programming of the rotational movement;
   programming of the longitudinal movement
   programming of the radial movement;
the control unit commands the machine tool, in accordance with the programmed longitudinal and rotational movement;
the machine tool generates the longitudinal and rotational movements, which are transmitted to the cutting tool through the coupling structure formed by the rotation adapter and the torque cone;
the torque cone in accordance with the programmed radial movement, which activates the command rod responsible for commanding the lift degree of the retractable blades based on the programmed value.

As a result, it is possible to effectively control the process of machining an internal channel, configuring the dimensions that characterize it—depth and width, for example, through the programming of the longitudinal, rotational and radial parameters.

### BRIEF DESCRIPTION OF THE FIGURES

For a better comprehension of this application, figures have been attached that represent preferential embodiments which, however, are not intended to limit the technique disclosed hereby.

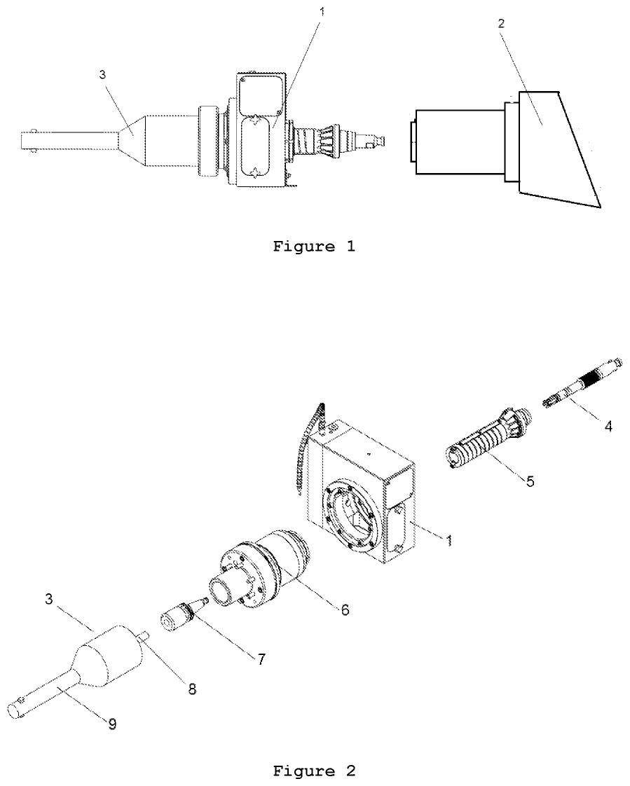

FIG. 1 represents the device for machining internal channels through machine tools, where the reference marks signify:
1—device;
2—machine tool;
3—cutting tool.

FIG. 2 represents an exploded view of the device for machining internal channels through machine tools, where the reference marks signify:
1—device;
2—cutting tool;
3—tether;
4—rotating interface;
5—rotating adapter;
6—torque cone;
7—internal rod;
8—cutting cylinder head.

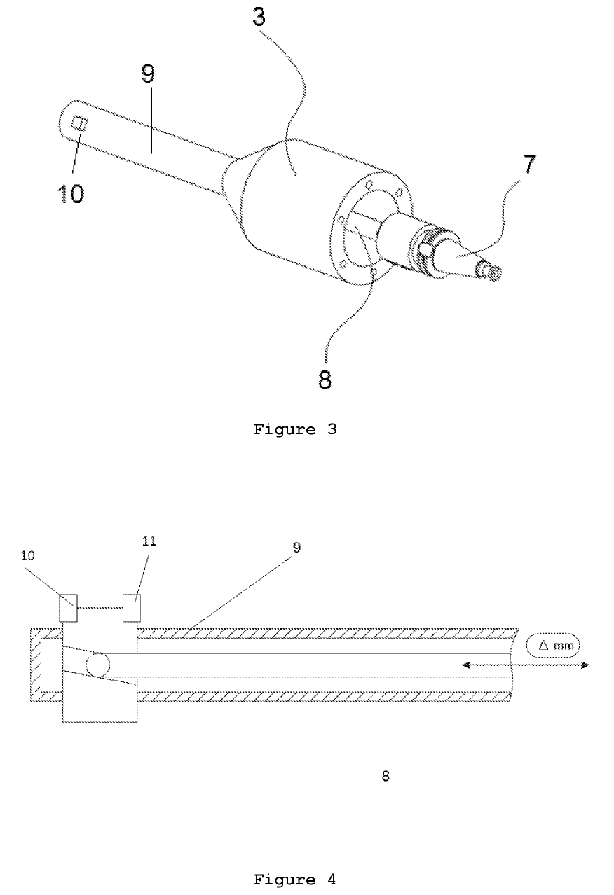

FIG. 3 represents the cutting tool, wherein the reference marks indicate:
3—cutting tool;
7—torque cone;
8—internal rod;
9—cutting cylinder head;
10—cutting blade.

FIG. 4 illustrates the inside of the cutting tool and the activating mechanism of the cutting blades, where the reference marks signify:
8—internal rod;
9—cylinder head;
10—cutting blade;
11—cutting blade.

### DESCRIPTION OF EMBODIMENTS

With reference to the figures, some embodiments are now described in more detail, which is not intended, however, to limit the scope of the present application. The machine tool (2) causes the rotation of the rotating interface (5) of the coupling structure of the device (1), through the mechanical connecting chain provided by the tether (4), which is coupled to the cited machine (2). This rotation, in conjunction with the longitudinal movement of the entire structure—device (1), cutting tool (3) and machine tool (2), allows for the creation of internal channels in the parts undergoing machining. These channels may have different depths, depending on the radial parameter which, in conjunction with the two aforementioned movements, are programmed by the operator at the control unit of the device.

In a particular embodiment, the rotational movement imposed by the machine tool (2) allows a maximum of 6000 rpm and a power of 33 kw. In order to allow the rotation movement to be transmitted to the cutting tool (3), in particular, its internal rod (8), is coupled to a rotation adapter (6), coupled to the rotating interface (5), which moves together with the fixing cone (7). In this particular embodiment, the cutting tool (3) comprises two cutting blades (10, 11) located in the cylinder head (9).

In order to initiate the process of machining the part that it is intended to work, the latter is placed with the cutting tool (3) by the action of longitudinal movements of the machine tool (2). Then, and with the rotational movement already initiated, the cutting tool (3) is introduced into the drill of the part to be machined, which was previously opened. In order to produce the internal channels, the controller of the device (1), after defining the necessary parameters—rotational, longitudinal and radial—which may vary depending on the specificities of each part to be machined, provokes a longitudinal movement in the rod (8) placed inside the cutting tool (3), which activates the cutting blades (10, 11) which allow the opening up of the intended channels.

In a particular embodiment, the longitudinal movement of the rod (8) can extend to a maximum of 150 mm, having been previously parameterized by the controller.

This description is clearly, in no way, limited to the embodiments presented in this document and a person with average knowledge of the field could foresee many possibilities of modifying it without departing from the general idea, as defined in the claims. The preferential embodiments described above are obviously combinable with each other. The following claims additionally define preferential embodiments.

1. A device for machining internal channels comprising:
a coupling structure for connection to a machine tool;
a cutting tool, for machining internal channels, connected to the machine tool through the coupling structure;
a computational unit comprising computational means adapted to operate the machine tool and the cutting tool;
wherein the coupling structure comprises:
a rotation adapter for connection to the machine tool;
a torque cone which connects to the rotating adapter; and
a command rod which engages the torque cone and which activates the cutting tool.

2. The device according to claim 1, wherein the cutting tool comprises a cutting surface equipped with at least one retractable blade activated by the command rod.

3. The device according to claim 2, wherein the cutting surface of the machine tool is of variable length.

4. The device according to claim 1, wherein the cutting surface of the cutting tool has a cylindrical geometry.

5. The device according to claim 3, wherein the length of the command rod is defined by the length of the cutting surface of the cutting tool.

6. The device according to claim 1, wherein the control unit comprises a communication module configured to establish the interaction with the controller of the machine tool.

7. The device according to claim 1, wherein the control unit comprises at least one peripheral input device and at least one peripheral data output device.

8. The device according to claim 7, wherein the peripheral data input device is of the keyboard type.

9. The device according to claim 7, wherein the peripheral data output device is a screen.

10. A method of operating the device for machining internal channels described in claim 1, comprising the following steps:
conducting parameterization of the operation parameters, in the control unit of the device by:
programming the rotational movement;
programming the longitudinal movement;
programming the radial movement;
commanding the machine tool via the control unit, in accordance with the programmed longitudinal and rotational movement;
generating the longitudinal and rotational movements, which are transmitted to the cutting tool through the coupling structure formed by the rotation adapter and the torque cone; and
activating, via the torque cone in accordance with the programmed radial movement, the command rod responsible for commanding the lift degree of the retractable blades based on the programmed value.
